(19) United States
(12) Patent Application Publication
(10) Pub. No.: US 2025/0264585 A1
(43) Pub. Date: Aug. 21, 2025

(54) SENSORS BASED ON OPTICAL TIME-OF-FLIGHT LIDAR TECHNOLOGY

(71) Applicant: CONNECTSIX LLC, CLEARWATER, FL (US)

(72) Inventors: Scott Allen Samson, Safety Harbor, FL (US); Lawrence Clair Langebrake, St. Petersburg, FL (US)

(21) Appl. No.: 19/056,159

(22) Filed: Feb. 18, 2025

Related U.S. Application Data
(60) Provisional application No. 63/555,039, filed on Feb. 18, 2024.

(51) Int. Cl. G01S 7/4865; G01S 7/481; G01S 7/4863; G01S 17/10

(52) U.S. Cl. CPC G01S 7/4865; G01S 7/4813; G01S 7/4814; G01S 7/4816; G01S 7/4863; G01S 17/10

(57) ABSTRACT

Devices and methods for Time-of-Flight (TOF) Light Detection and Ranging (LIDAR) detectors with applications in marine sensing and other environments. A light source includes one or more lasers or LEDs and emits a pulsed light beam into a medium. A TOF detector includes at least one photodetector element, and may include a linear or two-dimensional array of photodetector elements. Each photodetector element has at least one switch and storage capacitor. When the switch is closed, the capacitor stores charge from the photodetector element arising from returned photons from a target in the medium. The amount of charge accumulated on the capacitors is periodically read and evaluated to determine characteristics of the target. The switch timing is controlled based on the pulsed light beam timing and a TOF range to the target. Optical filters and lenses may be employed on both the pulsed light beam and the returned photons.

### CROSS-REFERENCE TO RELATED APPLICATIONS

This application claims the benefit of the priority date of U.S. Provisional Patent Application Ser. No. 63/555,039, titled SENSORS BASED ON OPTICAL TIME-OF-FLIGHT LIDAR TECHNOLOGY, filed Feb. 18, 2024.

### BACKGROUND

### Field

The present disclosure generally relates to sensors for measuring optical characteristics of targets in a medium. More particularly, it relates to a family of sensing instruments that use optical time-of-flight (TOF) light detection and ranging (LIDAR) technology. The instruments include a pulsed light source and a TOF sensor with at least one photodetector element which stores charge on a switched capacitor, where the amount of accumulated charge is analyzed to determine the optical characteristics of the targets.

### Discussion of the Related Art

Today's industrial, biomedical, and underwater optical instruments are generally comprised of one or more active light sources, optical filters to pass the desired signal wavelengths, one or more photodiodes or photo-multiplying detectors, custom circuitry, analog-to-digital converters (ADCs), and a microcontroller or computer to control the probing optics and detectors and electronics, and to process the raw optical signals into useful information. These instruments are often used to estimate the concentration or abundance of organisms. Most single-detector sensors utilize kHz-scale modulated light sources, and optical and electrical bandpass filters. These filters are used in attempts to reject more slowly varying ambient light. By selecting optical components and orientation, one can realize sensors to measure parameters such as fluorescence, scattering, and absorption at one or more wavelengths. These photodetectors connect to electronics to amplify the photon-induced electrons (photoelectrons), and then digitize these signals for digital processing. The amplification stage introduces electronic noise that masks subtle signals of interest. The noise contribution can generally be reduced by reducing the measurement bandwidth either of the analog electronics or through digital signal processing, but this comes at the expense of decreased temporal and spatial resolution and added complexity. To improve on the traditional single-sensor instruments, two-dimensional information can be produced by arrays of photodetectors (pixels). These image-generating sensors accumulate photoelectrons for an interval set by an electronic shutter lasting from a microsecond up to several seconds. Longer shutter times (integration time) improve signal-to-noise (SNR) by accumulating more photoelectrons. Unfortunately, long integration time also accumulates random, time-varying ambient photons caused by lighting changes (sunlight, fluorescent lighting, waves, clouds, etc.). The additional light integrated during a long integration period also contributes to statistical shot noise, adding measurement uncertainty. Sensor readout rates and the long shutter times used to collect weak signals severely limit the capability of digital ambient light subtraction techniques.

Light Detection and Ranging (LIDAR) techniques can improve signal-to-noise and at the same time provide ranging information. LIDARs often use higher peak optical power (yet typically low average power to make them eye-safe), monochromatic, and short-duration pulses (nanoseconds) of light to probe the environment or sample of interest. This combination reduces the influence of the ambient light field compared to the measurement techniques used in instruments today. Light travels at cs=3.0×10⁸/ns m/sec, or 0.224 m/nanosecond in seawater (for index of refraction ns=1.34). Sampling an optical parameter at a distance from the LIDAR instrument, z, can be done by measuring the photons returning to the receiver at a specific time interval, t(z)=2*z/cs. For the traditional LIDAR optical receiver, high-speed (GHz), time-synchronized photodetectors and electronics are used to measure the scene-reflected photons. These detectors have an intrinsic amplification capability; examples being photomultiplier tubes (PMT), avalanche photodiodes (APD), single-photon avalanche photodiodes (SPAD), or gated image-intensified CCD (ICCD) cameras. These intrinsically-amplified detectors typically produce a cascade of tens to millions of photoelectrons for each photon striking a detector surface. This cascade amplifies the signal and improves SNR for weak signals (though the process contributes some excess electronic noise). Unfortunately, PMTs and APDs require a precise and stable high voltage bias to produce stable gain, can be permanently damaged by high light levels, have thermal dependence of gain, and require high-speed amplifiers and analog-to-digital (ADC) sampling electronics; these characteristics make the entire detection and data handling system complex and costly. SPADs are highly nonlinear devices and produce excess spontaneous noise and have a reset interval after photon arrival during which they do not function. ICCD cameras cost tens of thousands of dollars but can produce range-gated images of the returned photons.

In an underwater sensing application, for example, because today's non-LIDAR sensors cannot discriminate modulated light reflected from nearby or from afar, they sense a limited volume of water (a few cubic centimeters) immediately adjacent to the sensors' optical windows. Creating depth profiles of water parameters requires dropping such conventional instruments from the side of a vessel or towing or propelling the sensor through various depths of the water column. When using towed or autonomous sampling systems to carry the sensor, the minimum sampling depth above the seafloor is dictated by safety of the instrument package to avoid causing damage to the sensor or benthic sea life.

In view of the circumstances described above, there is a need for affordable instruments to measure the optical properties of microorganisms in marine environments, including at varying depths in the water column, and for measuring atmospheric phenomenon, or for bio-medical and industrial applications.

### SUMMARY

The present disclosure describes Time-of-Flight (TOF) Light Detection and Ranging (LIDAR) sensors in configurations that provide improved-performance and cost oceanographic, atmospheric, industrial or biomedical optical instruments. TOF LIDAR sensors operate differently as compared to single-detector and arrayed detectors currently used in oceanographic phytoplankton sensors or used in the traditional amplified detector/fast detection LIDAR systems. Instead of amplifying and reading photoelectrons as they are generated in real time by using high speed off-chip electronics, TOF sensors accumulate the desired photoelectrons (charge generated by an incident photon), at each detector location on the detector. Prior sensors such as CCD or CMOS detectors, for example, use one relatively long exposure to light and a matched integration of photons. In TOF sensor, this accumulation is performed several temporally-distinct times (N), through a precise nanosecond-scale charge gating process whereby only photoelectrons arriving within the desired time intervals are transferred and stored on capacitors. These charges are integrated on the TOF detector sensor or array of sensors, on-chip. After accumulation of electrons from many tens, hundreds or thousands of light pulses, the accumulated charges are then read using moderate-speed (kHz to few MHz, i.e. lower cost) electronics. The on-chip accumulation significantly improves the signal-to-noise of the system by reducing the number of electronic readouts (and noise accompanying the readout) and greatly simplifies electronics and digital post-processing requirements. As an additional beneficial feature, some TOF detectors include two or more gating time intervals. In this manner, capture of light from two or more temporal phases (ranges) of the probing light can be measured. For instance, one interval can be configured to measure ambient light just prior to pulsing the light source, and the other intervals can detect light from one or more different range slices. Subtracting the two results essentially removes the average ambient light's contribution to the signal. Measuring the amount (e.g., ratio) of charge in two adjacent time intervals can be used to obtain more accurate ranging information than simply relying on the presence or absence of charge during the time interval.

Additional features of the present disclosure will become apparent from the following description and appended claims, taken in conjunction with the accompanying drawings.

### BRIEF DESCRIPTION OF THE DRAWINGS

FIG. 1A is a graph of optical signals versus time from a traditional detector as known in the art, and FIG. 1B is a graph of optical signals versus time from a TOF LIDAR detector according to embodiments of the present disclosure;

FIG. 2 is an illustration of a system including an optical time-of-flight LIDAR instrument that determines the distance to a target in a fluid volume, according to embodiments of the present disclosure;

FIG. 3A is a schematic diagram of a conventional optical detector as known in the art, and FIG. 3B a schematic diagram of an optical TOF LIDAR detector according to embodiments of the present disclosure;

FIG. 4 is a graph of 1-second average and 1-minute average fluorometer readings versus time from both a conventional optical detector and an optical TOF LIDAR detector according to embodiments of the present disclosure;

FIG. 5 is an illustration of an optical TOF LIDAR detector of the type depicted in FIGS. 2 and 3B, in a marine sensing environment, according to embodiments of the present disclosure;

FIG. 6 is a schematic illustration of an optical TOF LIDAR instrument of the type depicted in FIG. 5 with additional capability to measure spectral characteristics, according to embodiments of the present disclosure; and

FIG. 7 is an illustration of an optical TOF LIDAR instrument of the type depicted in FIG. 5, fully integrated into an underwater-deployable device with all electronics and a power supply enclosed in a pressure vessel, according to embodiments of the present disclosure.

### DETAILED DESCRIPTION OF THE EMBODIMENTS

The following discussion of the embodiments of the disclosure directed to sensors based on optical time-of-flight (TOF) LIDAR technology is merely exemplary in nature, and is in no way intended to limit the invention or its applications or uses.

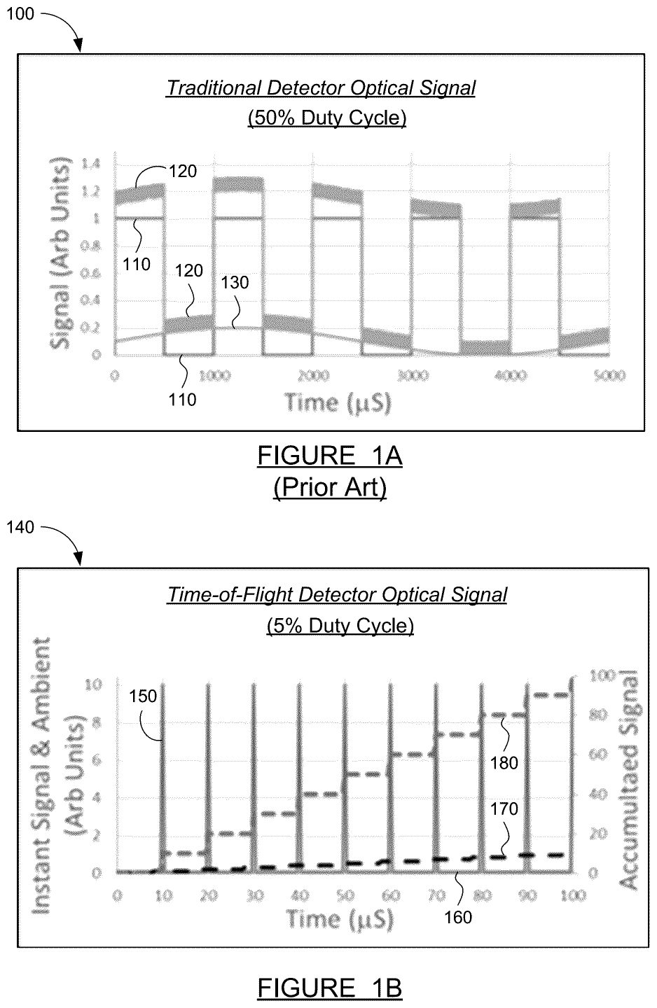

FIG. 1A is a graph 100 of optical signals versus time from a traditional detector as known in the art, and FIG. 1B is a graph 140 of optical signals versus time from a TOF LIDAR detector according to embodiments of the present disclosure. These figures provide a comparison of traditional and TOF optical detector signals, using equivalent average probing optical power levels. In FIG. 1A, the traditional detector signal fluctuates due to the contribution of ambient light and electronic noise. In FIG. 1B, the TOF detector uses higher peak power and a higher repetition rate, so the ambient light contribution and electronic noise is reduced relative to the signal. The TOF sensor captures and integrates both the signal and the ambient light in synchronization with each pulse so the ambient contribution can be simply subtracted in post-processing.

In FIG. 1A, the graph 100 illustrates example electro-optical signals in a traditional sensor's photodiode. It shows an idealized 1 kHz (50% duty cycle) modulated signal both before (plot line 110, which is indicated twice on the graph to highlight the step function shape) and after (plot line 120, thicker and also indicated twice) adding simulated time-varying ambient light and electronic noise. The time-varying ambient light signal is shown in a plot line 130, generally sinusoidal in shape in this simulation and low in amplitude.

In FIG. 1B, the graph 140 illustrates a re-scaled representation of TOF instant and accumulated signals produced when using ten times higher instant power pulse (but same average energy optical signal), with an example 100 kHz, 500 nS (nanosecond) pulse duration (5% duty cycle) probe and the same ambient and electronic read noise levels. The instant TOF device signal is shown in a pulse-shape plot line 150. The ambient light signal is shown in a plot line 160, which appears as almost zero magnitude because the Y-axis has been rescaled to accommodate the larger magnitude TOF pulses. The accumulated ambient signal is shown in a dashed plot line 170. The accumulated TOF signal plus ambient signal is shown in a dashed plot line 180. Because the pulse repetition rate is much higher and received signal intensity is ten times larger than the traditional sensor, the slowly varying ambient light fluctuations are relatively reduced. The ambient light photoelectrons are accumulated by the TOF sensor a few nS prior to (or after) each light pulse, and the signals are captured in precise synchronization with each light pulse return. In this way, the contribution of ambient light can be nulled out in simple post-processing. The integrated photo-electron signal increases by the number of light pulses used (only a few cycles are shown), so after e.g., 10,000 pulses, the signal would grow to 100,000 (compared to 1 for traditional sensors). Thus, the electronic read noise introduced during readout is made comparatively small to the desired signal. This benefit alone represents a substantial advantage of a TOF approach over traditional methods.

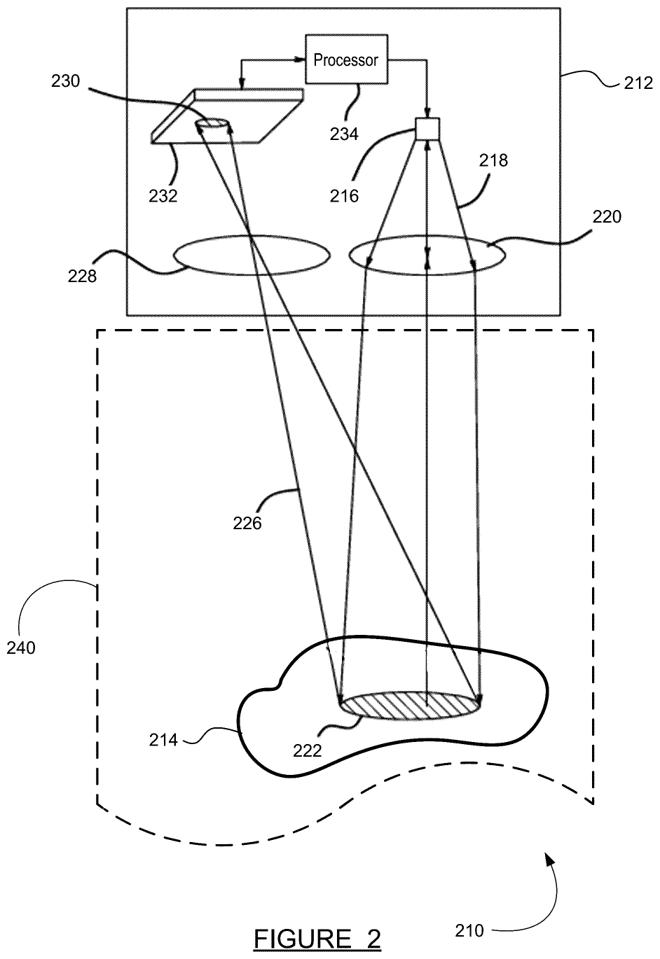

FIG. 2 is an illustration of a system 210 including an optical time-of-flight LIDAR instrument 212 that determines the distance to a target 214 in a fluid volume 240, according to embodiments of the present disclosure. FIG. 2 describes the basic elements and concepts involved in the presently disclosed sensors based on optical TOF LIDAR technology, the details of which are discussed further below.

In FIG. 2, the volume 240 may be lake or sea water and the target 214 may be a piece of algae, for example. The instrument 212 includes a laser 216 suitable for the purposes described herein that emits a pulsed laser beam 218 that is collimated by a collimating lens 220 and projected as a laser spot 222 on the target 214. In alternate embodiments, the laser can be other types of light sources, such as an LED, that emit pulsed light beams. A portion of a reflected beam 226 from the laser spot 222 on the target 214 is reflected back towards the instrument 212 and is focused by a focusing lens 228 as an image 230 of the spot 222 on a gated TOF sensor 232. The TOF sensor 232 does not require, but may benefit from, avalanche gain. The lateral position of the image 230 on the sensor 232 is not required to be centered on the optical axis of the lens 228. More specifically, offsetting the sensor 232 relative to the optical axis of the lens 228 may be beneficial because an illuminated target closer to the instrument 212 is focused onto one portion of the sensor 232, while a further-distant target is imaged onto a separate region on the sensor 232, as will be discussed in detail below. Beam generation and image processing electronics 234 controls the generation of the laser beam 218 and processing of the image 230 detected by the sensor 232.

Using optical TOF LIDAR technology, the instrument 212 includes design features which enable significant improvements in performance and capability over conventional detectors. An example of the dramatic improvement in signal-to-noise ratio of the disclosed instrument as compared to a conventional detector is illustrated in FIGS. 1A and 1B.

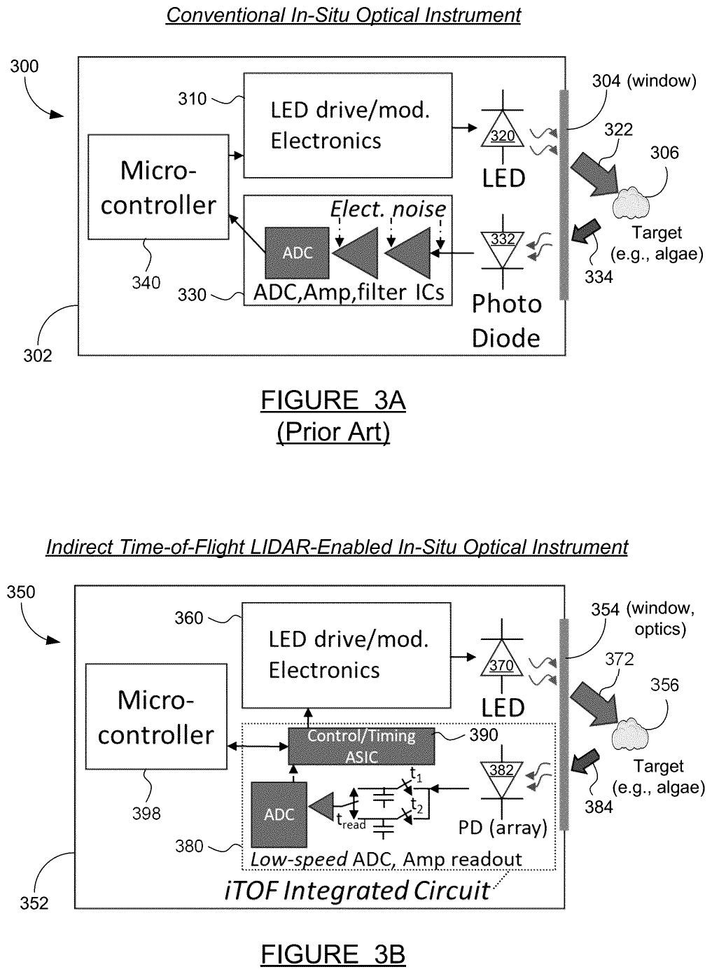

FIG. 3A is a schematic diagram of a conventional optical detector 300 as known in the art, and FIG. 3B a schematic diagram of an optical TOF LIDAR detector 350 according to embodiments of the present disclosure. The schematic diagrams of FIGS. 3A and 3B illustrate the differences between the conventional detector design and the TOF LIDAR detector design, and the following discussion describes how those differences are manifested in the significant performance and capability benefits of the presently disclosed TOF LIDAR detector 350.

The conventional optical instrument 300 in FIG. 3A has a housing 302 containing all electronic components, and a window 304 through which light beams (i.e., optical signals, photons) pass—including both light beams sent from the instrument 300 and reflected or fluoresced light beams received by the instrument 300. The reflected light beams are reflected off of a target 306, such as a piece of algae as shown.

An LED drive/modulation electronics module 310 sends signals to an LED 320, which sends light beams 322 through the window 304 into the aquatic environment, where some of the light beams 322 will strike the target 306. As shown in FIG. 1A, the light beams 322 sent by the LED 320 in the conventional optical instrument 300 are characterized by an on/off step function shape, with relatively long duration on and off times, at a duty cycle of approximately 50%.

A sensor module 330 receives electrical signals from a photo diode 332, which in turn receives reflected light beams 334 from the target 306. The electrical signals produced by the photo diode 332 are in response to the photons in the reflected light beams 334, such that increased intensity of the reflected light beams 334 results in increased electrical output from the photo diode 332. The sensor module 330 includes various electronic components designed to process the electrical signals from the photo diode 332. These components include one or more integrated circuits, filters, amplifiers and an analog to digital converter (ADC). The electrical signals from the photo diode 332 must be processed as they are received, on a time scale of microseconds, which means that all of the components in the sensor module 330 must operate at high speeds in order to process and measure the amount of light energy detected by the photo diode 332.

The electronic components in the sensor module 330 operate on analog data, up until the ADC finally converts the signal to digital and provides the digital measurement signal to a microcontroller 340. All of the electronic components in the sensor module 330, and the interfaces therebetween, create opportunities for electronic noise to affect the processed signal. The effect of the noise was shown in FIG. 1A and discussed above.

The microcontroller 340 receives the digital measurement signal from the ADC in the sensor module 330, and determines a value for an output reading—such as a measured fluorescence of the algae target. The microcontroller 340 also communicates with the LED drive/modulation electronics module 310 to control the operation of the LED 320.

The optical TOF LIDAR instrument 350 in FIG. 3B has a housing 352 containing all electronic components, and a window 354 through which light beams pass-including both light beams sent from the detector 350 and reflected light beams received by the instrument 350. The reflected light beams are reflected off of a target 356, such as a piece of algal material as shown. For the purposes of this diagram, the window 354 consists of optics as well—including the collimating lens 220 and the focusing lens 228 illustrated in FIG. 2. In an actual physical device, the lenses 220 and 228 may be separate elements from the window which provides a waterproof seal of the housing 352 while allowing light beams to pass through.

The optical TOF LIDAR instrument 350 includes an LED drive/modulation electronics module 360 sending signals to an LED 370, which sends light beams 372 through the window 354 into the aquatic environment, where some of the light beams 372 will strike a target 356. As shown in FIG. 1B, the light beams 372 sent by the LED 370 in the optical TOF LIDAR detector 350 are characterized by high intensity, short duration pulses.

A sensor module 380 in the TOF LIDAR instrument 350 has a completely different design and method of operation than the sensor module 330 of the conventional optical instrument 300. The sensor module 380 includes a photodetector 382, which may comprise a single pixel or may include a 1D or 2D array of detector elements. For the purposes of this discussion, consider that the photodetector 382 includes one detector element with two dedicated switching elements and storage capacitors, as shown on the two branches in the middle of the sensor module 380.

Reflected light beams 384 (from the target 356) impinging on the detector element in the photodetector 382 create electrical signals. The detector element sends its electrical signals to a first branch including a switch (such as a field effect transistor (FET) switch) and a storage capacitor. A second switch sends its electrical signals to a second storage capacitor. The timing of the switches do not overlap and are controlled by a timing module 390, which may be an application-specific integrated circuit (ASIC) as shown, or external to the iTOF integrated circuit. The on-timing of the two switches is selected based on the timing of the pulses of the light beams 372 from the LED 370 and a desired amount of elapsed time required for the pulses to reach the target 356 at a particular range and return as the reflected light beams 384. If the switch for a particular detector element is not closed at a certain instant of time, any photons impinging on that detector element will not be accumulated in the corresponding storage capacitor. As shown in FIG. 3B, each switch can operate on a separate switching time cycle.

The storage capacitors for each detector element accumulate charge based on the amount of reflected light hitting the detector element and the switch timing. At a certain time (designated t_read), the amount of charge on each of the storage capacitors is read by an amplifier, converted from analog to digital by an ADC and provided to a microcontroller 398.

The time t_read occurs after many cycles of the switching pulse on the detector element branches, and at that time, the amplifier simply reads the accumulated charge on the storage capacitors. The amplifier and the ADC do not necessarily need to receive and process electrical signals from the detector elements on a nanosecond or microsecond time scale. Thus, the ADC and the amplifier reading the capacitors can be low speed components; this allows lower cost and more robust components to be used, and the opportunity for introduction of electronic noise is greatly diminished.

The timing module 390 communicates with the microcontroller 398. The timing module 390 controls both the timing of the light pulses sent by the LED 370 and the timing of the switches on the branches of the detector elements in the photodetector 382. The LED 370 can be multiple LEDs that send multiple light beams 372 of same or different color (wavelength) to suit application requirements, and the timing of the switches (the elapsed time after each sent light pulse) can be adjusted depending on desired ranges. This is discussed further below.

Following is a summary of the operation of the optical TOF LIDAR instrument 350 depicted in FIG. 3B and described above. Controlled by the LED drive/modulation electronics module 360, the LED 370 sends pulsed light beams 372 through the window 354 and corresponding optics (lens) for the light beams. The LED 370 may include multiple individual LED elements and may send multiple light beams 372 of different colors (wavelengths). The photodetector 382 receives the reflected light beams 384 reflected from the target 356. For each detector element in the photodetector 382, the corresponding FET switch closes at a time which is determined based on time-of-flight for a particular sensing range, and the corresponding capacitor accumulates charge based on the number of photons from the reflected light beams 384 striking the detector element. After a certain amount of time (t_read), the amplifier in the sensor module 380 passes the accumulated charge in the capacitor for each detector element to the analog-to-digital converter (ADC). The amount of charge accumulated on the capacitor for the detector element indicates an optical property of the target (e.g., the intensity of phosphorescence), and the corresponding FET switch timing for the detector element determines the sensing range. When more than one detector element is used (e.g., a linear or 2D array), additional information is obtainable simultaneously—including monitoring of multiple sensing ranges, and determining other properties (e.g., size) of the target 356.

Some TOF detectors (in the sensor module 380) include on-chip or supplementary application-specific-integrated-circuits (ASICs) for synchronizing the probing light pulses, controlling the time-gating, and performing lower-speed analog-to-digital conversion of the on-pixel accumulation of signals and ambient light references. Other TOF detectors utilize off-chip circuitry, either as an ASIC or discrete circuitry. Especially when provided on-chip, the integrated circuitry can greatly simplify overall system design and can substantially reduce the cost of the entire sensor system while minimizing the influence of external electronic noise sources. Auto-sampling functions can perform the light pulsing and sampling autonomously with the system microcontroller in a sleep state, which can further improve energy efficiency.

The TOF detector's features improve signal-to-noise beyond levels previously attainable using the traditional intrinsic-gain detectors while markedly reducing the system requirements including power supplies, ancillary electronics, and data post-processing. Unlike avalanche photodiode (APD) and photomultiplier tube (PMT) photodetector technology, the disclosed TOF detectors operate using low-power, low-voltage CMOS-compatible (e.g., 3.3V) circuitry and are robust to thermomechanical and bright light stresses. In the case of pixelated TOF detectors, a 3D image can be produced or a depth-resolved optical signal received from the scene, without mechanical scanning.

From an operational standpoint, the disclosed TOF detectors can be configured to capture an enormous useful dynamic range of signals, starting from less than an average of one photon of signal received per probing light pulse. The dynamic range of TOF detectors can be extended far beyond just the readout analog-to-digital converter (ADC) digital resolution (e.g. typically 12-16 bits on the ADC), by accumulating different numbers of light pulses (one pulse to many thousands of pulses) per measurement readout. This can effectively produce up to an additional 15 bits or more of programmable dynamic range (this equates roughly to 100 dB of total signal level dynamic range). Some TOF detectors contain special circuitry or readout methods to prevent saturation of the integration capacitors, this includes non-destructive readouts (NDR) or mirrored charge bleeding (MCB) of each photoelectron accumulation capacitor on the detector pixel. Each of these range-extension features may be performed on-the-fly during sampling and acquisition. This enables sensitive operation of TOF-based instrumentation from high dynamic range targets without saturation of the charge storage capacitors or readout electronics.

Following is a discussion of one embodiment of simple single-detector developed as a prototype: a TOF-based chlorophyll fluorometer instrument for sampling near the sensor's optical components. It is noted that the target analyte (chlorophyll) can be readily changed to measure other analytes by appropriate selection of excitation and emission wavelengths (e.g. colored or fluorescent organic matter, oil, or hydrocarbons, photosynthetic accessory pigment such as phycoerythrin, phycocyanin or the like). The fluorometer utilized a printed circuit board (PCBs) with a single 400×400 μm² photodiode as part of a TOF detector. An illumination PCB includes a 400 to 480 nm blue light emitting diode or laser (or other color that can excite chlorophyll either directly or through accessory pigments in the algae cells) along with a fast field-effect or other type transistor or switch to quickly turn on/off the LED current and its optical emission within a few nanoseconds (can be faster or slower as required). This light is used to excite chlorophyll-a/b in an aqueous solution. This could readily be used to excite chlorophyll in terrestrial samples also. The excitation optics were mounted in an opaque lens tube with a blue-pass optical filter at its output aperture to block any fluorescence or light produced by the LED or circuit board materials that could reach a detector (discussed next). For this algae detection prototype application, the blue excitation light was directed into the side of a glass tank filled with fresh tap water. The tank side and electronics could be housed in an appropriate pressure vessel to keep water from negatively interacting with the electronics.

Chlorophyll is well known to fluoresce near a wavelength of 695 nm when excited by light of wavelengths approximately 400 to 480 nm. A detector is made comprising a long-pass optical glass filter (>570 nm) to exclude any excitation photons, a lens to coarsely focus fluorescence energy, and the TOF detector. A bandpass filter or combination bandpass and long-pass filter can be alternately used. In this embodiment, a microcontroller commanded the TOF chip to trigger 5-380 nS pulses of light from the LED board, and to capture a pulse-synchronized signal (with appropriate LIDAR delay to account for time-of-flight of the light to reach the target area, for the chlorophyll to fluoresce, and for the fluoresced light to return to the detector) and captured a similar duration of ambient light just prior to LED pulsing. The microcontroller computed 1-second and 1-minute rolling averages of the pulse-integrated background-subtracted signal, and for reference, concurrently sampled a digitized commercial underwater sensor's fluorometer and backscatter outputs channels. As an example, a solution of dried spirulina powder was prepared using available activated carbon filtered tap water. The chlorophyll concentration was estimated using a known technique.

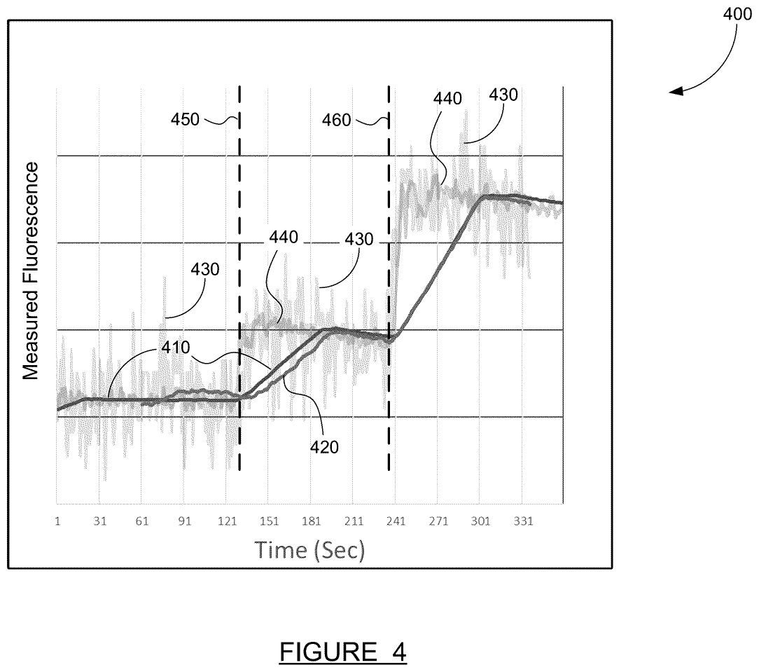

FIG. 4 is a graph 400 of 1-second average and 1-minute average fluorometer readings versus time from both a conventional optical instrument and a lab-based optical TOF LIDAR instrument according to embodiments of the present disclosure. The data shown on the graph 400 was obtained using the experimental setup described above.

A plot line 410 traces the 1-minute average fluorometer readings from the prototype optical TOF LIDAR detector of the present disclosure, and a plot line 420 traces the 1-minute average fluorometer readings from the commercial sensor. Being 1-minute averages, the plot lines 410 and 420 are observed to be well-behaved, without a lot of rapid fluctuations. A plot line 430 (labeled in three places on the graph 400) traces the 1-second average fluorometer readings from the commercial sensor, and a plot line 440 traces the 1-second average fluorometer readings from the prototype optical TOF LIDAR detector of the present disclosure. Being 1-second averages, the plot lines 430 and 440 are observed to include rapid fluctuations. However, it can be clearly seen that the 1-second average readings from the disclosed optical TOF LIDAR detector have much smaller fluctuations than the 1-second average readings from the commercial instrument.

FIG. 4 also shows the fluorometer data during addition of diluted Spirulina solution—estimated increases of 0.88 μg/L and 2.2 μg/L Chl-a within the tank from two additions approximately 2 minutes apart-indicated by dashed lines 450 and 460, respectively. It can be observed that the disclosed optical TOF LIDAR sensor tracks the commercial device's signal, and the device of the present disclosure has improved signal-to-noise. The commercial sensor is near its ADC resolution limit at the +0.88 μg/L Chl-a increase, increasing by only 6 ADC counts, whereas the disclosed TOF-based setup has dynamic reserve, which can be used to improve sensitivity or operate in large dynamic range of environments (e.g. estuarine to blue water).

Below is described an example optical instrument, of the disclosed TOF LIDAR detection type, which is capable of sensing an analyte away from the optical sensor components. To illustrate using a TOF detector to sense fluorescence of phytoplankton at range away from the instrument optical face, a calculation is initially presented. In an example implementation, a light source, such as a 5 W laser, using e.g. 10 nS-duration pulses with e.g., 10% duty cycle is collimated and projected into a 1 cm² cross section of water. At phytoplankton concentration 1000 cells/L, one cell is illuminated per cm range. It is estimated that a harmful algal bloom (HAB) cell cross section is 20×20 μm, that it absorbs 30% of photons striking it, and the fluorescence yield is 1%. Initially neglecting absorption and scattering in the water column, this results in 60 nW of fluoresced power, which corresponds to only 1,800 photons per 10 nS pulse (at ca 690 nm wavelength). These photons are emitted into 2π Steradians. Using a 50 mm f/2 imaging lens with focus at 5 m (magnification 49:1), on average only 0.011 photons per pulse reach the lens and are focused onto the detector. However, because a TOF detector can accumulate over many tens to thousands of pulses, detecting such small signal is not hopeless (whereas it would be when using traditional optical detectors and electronics). If the sensor is towed through the water at 1 m/s, the phytoplankton cell is imaged onto a single 10 μm wide TOF pixel (at the 49× magnification) for 490 μS, which is long enough for 54 photons from 4,900 pulses to be accumulated. Assuming electronic read noise is 2.5 electrons (e-), a reasonable signal-to-noise of 22:1 could be ideally expected in very clear water. In practice, attenuation, scattering, and inefficiency of fluorescence into the detector passband will reduce this, even substantially in near-shore waters. However, a 10 nS duration light pulse will illuminate several tens of cm of water depth at a time, which will improve the signal by imaging and detecting fluorescence from multiple algae cells simultaneously. Using such methods, sensing range much greater than traditional fluorometers (i.e., meters versus 1 cm) is achieved.

In one embodiment, the aforementioned pulsed laser or an LED is collimated and projected into the region of interest. A TOF-based detector (single pixel) or 1-D or 2-D arrayed TOF detector camera is placed adjacent to the LED and collects light or images the region of interest (with appropriate detection lenses and bandpass filters). By selecting the integration time start and duration of the collected light relative to the pulsed illumination, light emanating from the range of interest is integrated and measured after capturing multiple illuminating pulses' returns. As an example, if a 5 nS pulse of light (which is approximately 5 feet long, in air) is emitted from the laser, the LIDAR return from a hard target at 10 feet range will be returned from 20 nS to 25 nS after the start of the outgoing laser pulse. A TOF detector with gating interval starting 20 nS after the outgoing light pulse and for a duration of 5 or more nanoseconds would collect light from this range.

It is well known that using two consecutive time-collection intervals may be utilized to improve the depth resolution when ranging from hard targets. A ratiometric measurement of the energy received during the two collection intervals can be used to accommodate limitation in switching speed of the TOF detector. For instance, one detector TOF-capacitor can be connected to the photodiode from 5 to 20 nS after the probing light pulse and another of the detector's TOF-capacitors turned on from 20 to 35 nS. In the case of a hard target at 10 feet range, all the potential received energy will be accumulated in the second capacitor. In the case of a 9′ target range, approximately ⅖ of the photons will be received in the first capacitor and ⅗ of the photons in the second capacitor. In the case of an 8′ target range, ⅘ of the photons will be accumulated in the first capacitor and ⅕ of the photons will be accumulated in the second capacitor. In the case of a 2.5 to 7.5′ hard target range, all of the available returned photons will be accumulated in the first capacitor and none in the second capacitor.

It is also known that sequentially varying the timing of the relative phases (e.g., by 0, 90, 180, 270 degrees) between the first and second capacitor relative to the outgoing laser pulse can be used to determine the effect of ambient lighting. This can be useful if the ambient lighting is varying slowly relative to the integration time before readouts. If the ambient lighting is varying significantly between the phase readouts, an additional TOF-capacitor that measure ambient light outside the expected return pulse interval is preferred (e.g., prior to sending out each light pulse).

In another embodiment where the target object characteristics are desired (such as its fluorescence lifetime characteristics), two or more wavelengths can be used to determine both the range and characteristics. For example, in the case of a plant leaf containing chlorophyll, a red-light pulse (e.g., 690 nm) can be used to precisely measure the distance to the leaf, using the time-of-flight timing or ratiometric techniques of the reflected signal. Then, another illuminating wavelength, such as light in or around the range of 360-480 nm or near the 630 nm absorption peaks of chlorophyll can be used to excite the chlorophyll process, and an e.g., 690 nm optical bandpass filter and TOF detector used to measure the leaf's fluorescence. An increase in delay between the probing and fluorescence signals relative to the reflected LIDAR signal can thus be attributed to the fluorescence temporal characteristics. This can be used, for example, to estimate photosynthetic activity or cell health. It is noted that such a process is not limited to measuring the optical-temporal characteristics of chlorophyll. This technique can be used to excite accessory pigments that tie to the photosynthetic process (e.g. excite phycocyanin, phycoerythrin, beta carotene, etc. at appropriate wavelengths. The detector can measure the pigments' fluorescence properties or its ability to sequentially excite the chlorophyll process). Or it could be useful to measure photo quenching of materials (such as used for biomedical applications, oxygen sensing, optical brighteners, etc.).

As another sensing application example, the disclosed TOF detector is read out in a time sequence of multiple readings. This may be done in the presence or absence of external continuous, synchronized, or asynchronous light pulses. This may be useful for characterizing fluorescing processes that are photobiologically driven, such as photosynthesis. The sequential readings performed over the time series (microseconds to minutes) can be used to estimate the level of dark adaptation, photosynthetic activity, or health of a photosynthetic organism, which can be of great use in agriculture or aquaculture.

In another embodiment, two or more wavelengths of excitation or detection light may be used to provide better discrimination between different classes or species of organisms. For instance, a blue light source (e.g., in the range of 400-490 nm) can be used to excite and measure chlorophyll fluorescence, and a red detection used to measure the produced fluorescence. An example additional wavelength could be used, such as applying individually or additional pulses of green (e.g., 520-550 nm) or red (580-650 nm) light to stimulate accessory pigments of e.g., phycoerythrin or phycocyanin, which fluoresce at an orange wavelength and may be detected directly or via its indirect absorption by chlorophyll at the accessory pigment's fluorescence wavelength and which is re-emitted at the longer red wavelength detection channel for chlorophyll.

In another embodiment, better discrimination of a range-gated signal in the presence of scattering particles in front of or behind the range of interest may be enabled by using a one-dimensional array (i.e. line of detectors), or a two-dimensional array of TOF detector instead of a single detector element. The individual detector elements may but are not required to be continuously adjacent to each other. The need for better discrimination may arise due to optical pulses and available TOF-gating being longer in space-time than the desired resolution of the depth sensing, especially when viewing non-hard targets (e.g. analytes in liquid or gaseous solutions or suspensions). When performing in-air (low scattering) LIDAR, the air or aerosols closer to the sensor produce optical LIDAR return strengths that are generally weaker in amplitude than of even more distant hard semi-reflective targets. Thus, it is relatively simple to detect the range to the target by the transit time of the light pulse to-and back-from the target. However, if there is a need to detect or remove reflections, fluorescence or scattering from large signals produced by distributed near-sensor or beyond the desired range object or particles, the previously known methods of improving depth resolution by ratioing adjacent time slots may not work well. Moreover, large LIDAR returns can saturate a detection channel that is co-located spatially with the ranged target of interest. To solve this problem of not being able to discriminate a target at range from temporally overlapping optical returns, this embodiment includes the use of a spatially separated emitter and pixelated TOF array to spatially offset on the detector the range signal of interest from the unwanted signals at differing ranges.

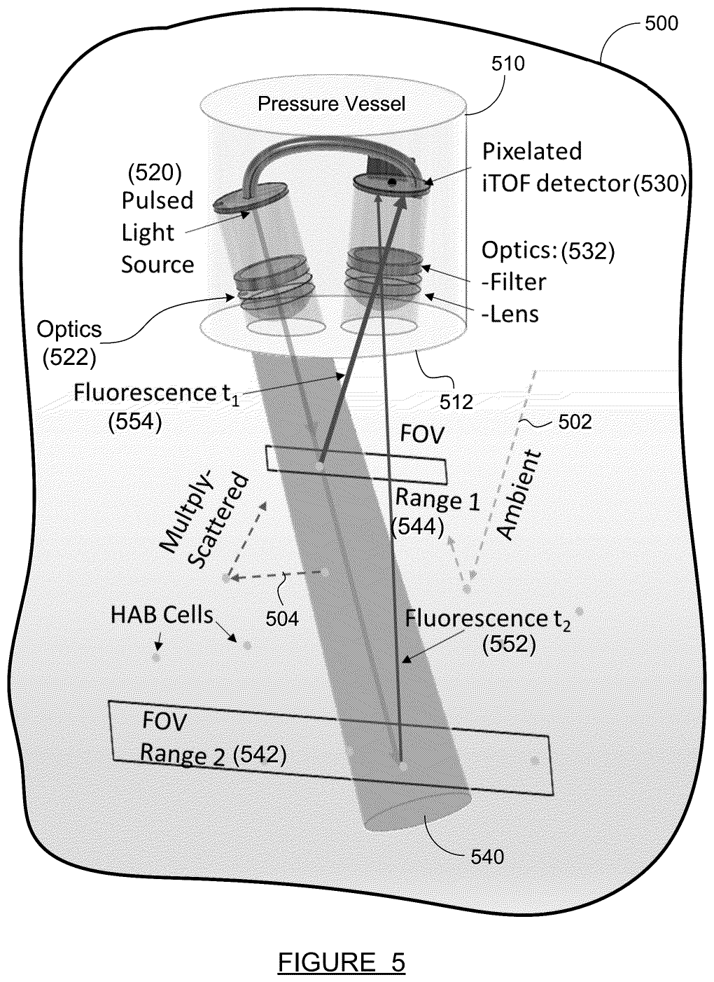

FIG. 5 is an illustration of an optical TOF LIDAR detector of the type depicted in FIGS. 2 and 3B, in a marine sensing environment, according to embodiments of the present disclosure. The underwater environment is depicted as a volume 500. The optical TOF LIDAR detector of FIG. 5 has a housing 510, illustrated as a pressure vessel with a window 512, which correspond to the housing 352 and the window 354 of FIG. 3B. A pulsed light source 520 corresponds to the LED drive/modulation electronics module 360 and the LED 370 of FIG. 3B, and a pixelated indirect time-of-flight (iTOF) detector 530 corresponds to the sensor module 380 of FIG. 3B. In this illustration, the iTOF detector includes a two-dimensional array of photodetectors 382 of FIG. 3B each having sampling switches and storage capacitors. Optics 532 include one or more optical filter and/or lens acting on the reflected light beams which are received by the iTOF detector 530. Optics 522 include one or more optical filter and/or lens acting on the light beams issued from the pulsed light source 520. The projection lens or the imaging lens may be comprised of or include an optical fiber configured to project the pulsed light beam to or from the target. Other elements depicted on FIG. 5 are described in the discussion below.

FIG. 5 illustrates an example spatially offset design embodiment (i.e., the light source 520 and the detector 530 have offset positions and intersecting axes) for use as an underwater sensor: a compact, low-cost high-sensitivity fluorometer capable of detecting HAB (algae) cells (or other targets) at multiple ranges away from the instrument. The water is probed using an outgoing nanosecond-pulsed light source (diverging cylinder 540 in FIG. 5). The desired scattered or fluoresced algae/HAB-target signals are measured by the time-gated TOF detector 530, whose detection intervals are synchronized and delayed to roughly the desired target range to the returning light pulses (reflective or fluorescence, for example). Photons emanating from a range determined by the light's transit time, from the light source to the target and back to the TOF detector, allow detection of water constituents including HABs from a programmable coarsely defined (by the gating resolution) standoff range, even in the presence of potentially much brighter time-varying ambient (dashed arrows 502) and scattered light (dashed arrows 504) noise. In additional to temporally detecting signal photons at a range from the instrument face, this embodiment includes a 1-dimensional or two-dimensional TOF array of pixels in the sensor 530 to provide additional spatial discrimination of potentially weaker signals coming from longer ranges (e.g., Range 2, 542) from stronger close ranges (e.g., Range 1, 544). This additional discrimination (improvement in depth resolution) is because photons originating from the respective illuminated volumes will be imaged onto different areas of the field of view (FOV) of the TOF detector array's pixels (e.g. on pixels on the left of the detector's FOV1 and to its right portion at FOV2). This is illustrated in FIG. 5 by an arrow 552 representing the reflected fluorescence from the Range 2 (542) arriving at a time t₂, and an arrow 554 representing the reflected fluorescence from the Range 1 (544) arriving at a time t₁.

In the preferred embodiment, a pulse of light is transmitted into the area of interest and this light is spatially separated, laterally and/or angularly from the TOF detector array. Due to the spatial offset and resulting parallax effects, the position where nearer target returned light pulses are imaged onto the TOF detector 530 is different than a farther target's position. This spatial separation can be used to provide additional range precision or discrimination in the presence of unwanted scattering features than timing of the TOF gating alone would. The spatial and temporal separation may also be useful to remove the effects of biological growth on optical windows, as signals arising from this growth will arrive earlier (closer range) and be spatially offset relative to the target sampling volume and may be completely out of the field of view of the detector or arrive earlier than far away signals.

In another embodiment, the timing of the fluorescence (or slower, phosphorescence) process is measured using the TOF detector by observing a fixed volume of water and determining the fluorescence time delay relative to the excitation light pulses either by delaying the detection phases relative to the excitation light pulses or by measuring the change in ratio in amplitude between two or more adjacent detection time slots. In the presence of ambient light, methods which sample the ambient light slightly before or long after the excitation/fluorescence process may be utilized. The implementation could include a third time-sampling integrator or a dual-collection method whereby each time channel samples in-phase as well as out-of phase (ambient) for some portions of its sampling channel, and varies the phases through multiple readings to estimate ambient light levels.

In another embodiment, the ambient light field in a region of interest may be estimated from nearby un-illuminated pixels, instead of a using and requiring a distinct ambient time-capture capacitor for that purpose. For instance, the ambient light field on an area on the active pulsed-light illuminated portion of pixelated TOF sensor area may be estimated by measuring the signals from nearby un-illuminated pixels, at the same time as the TOF-capture interval. The un-illuminated pixels may be a good estimate of the ambient light levels on the illuminated pixel areas of interest. Subtracting the un-illuminated signal from the illuminated signal can provide a reasonable estimate of only the active LIDAR return signal. This may be especially true for objects having slow spatial variance and smaller illuminated extent than the TOF array. This method can be especially useful for TOF sensor arrays that have the capability to measure one or two phases of the LIDAR return (i.e., a 1-or 2-switch and capacitor design).

In another embodiment, the TOF detector is used as the detector of an optical spectrometer. Current spectrometers utilize a grating (or prism, or variable optical bandpass filter, etc.) to cast a spectrally dispersed or filtered input aperture's light profile onto a CMOS or CCD detector array (1-D or 2-D). In spectrometer instruments, various portions of the detector's pixels receive different wavelengths. Current instruments are practically capable of spectrally/temporally resolving only relatively long-duration (>1 μS to seconds) optical signals. When light levels are weak (as in the case of fluorescence or when spectrally dispersing light faraway objects of interest, or using a very narrow entrance slit, for examples), long duration exposures need to be performed to accumulate sufficient signal beyond the detector's electronic noise, and the measurements are necessarily performed in a dark housing. This dark housing is needed because if the ambient light field is varying during the long measurement, either temporally or spectrally, large variation in spectral measurements can result, making extraction of the desired object spectrum impossible. In this new embodiment, a time-gated two-or-more phase TOF detector array is used in lieu of the CMOS/CCD array. This configuration is used to spectrally sample both the ambient and pulsed light field, for each illuminating pulse. In this manner, variations in the temporo-spatial light profile produced by the ambient light is captured just prior to (or after) the pulsed light capture. Subtracting the integrated multi-pulsed accumulated ambient light spectral signal from the multi-pulsed accumulated ambient plus pulsed light spectral signal yields a precise ambient-light-rejected optical spectrum. This embodiment has numerous applications in sensing especially in environments where operation in a darkened enclosure is unwieldy or impractical (outdoor, industrial, military, to name a few). As in a previously described embodiment, this spectral-sensing embodiment could use two adjacent time slots to measure the relative temporal output of the light. Taking the ratio (with or without subtracting or compensating for the ambient light contribution) of these adjacent time slots can provide an estimate of fluorescent decay (or small change in range, or other fast temporal processes) that is much better resolved than can be accomplished using a single several nano-second gated capture of the spectral information.

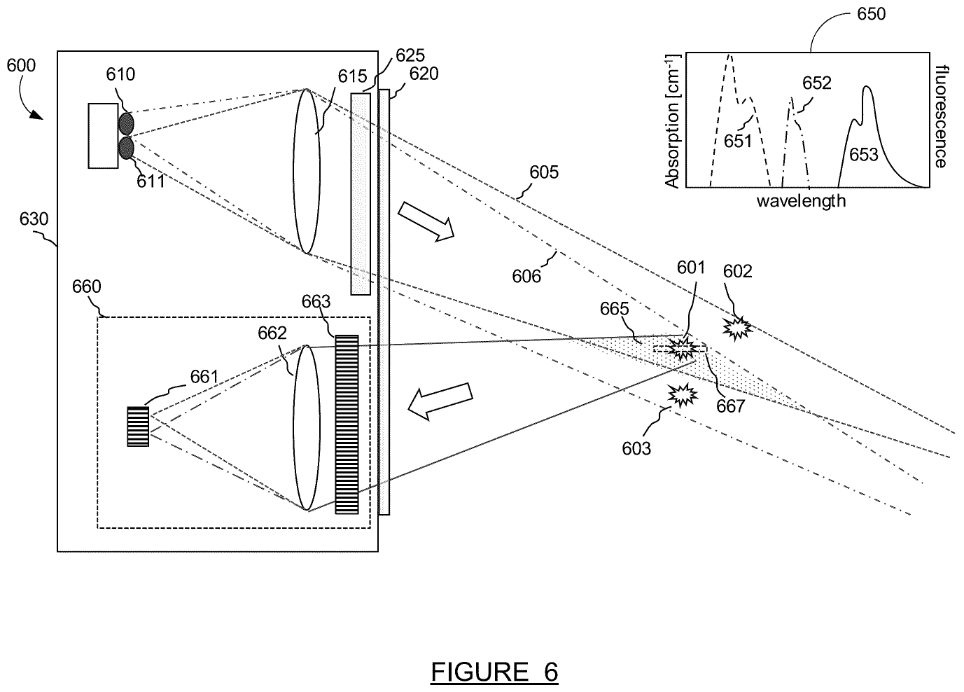

FIG. 6 is a schematic illustration of an optical TOF LIDAR instrument 600 of the type depicted in FIG. 5 with added functionality of measuring the spectral characteristics of targets. Targets 601, 602 and 603 are illuminated by one or more beams of light 605, 606 produced by focusing light from pulsed emitters 610, 611 respectively through the use of a lens 615, and after passing through a window 620 in an enclosure 630. The window and enclosure combine to protect the internal electronics and permit passing of light. A filter 625 may be inserted into the illumination path to reduce or remove the intensity of specific wavelengths of light. The targets 601-603 may have specific spectral characteristics (illustrated in a graph 650) that include absorption or reflection characteristics at some wavelengths 651 and 652 or fluorescence characteristics 653 at longer wavelengths compared to at least one absorption wavelength. These absorption or reflection characteristics may be used to determine the wavelengths of the light sources 610-611 and filters 625 to be used in the instrument 600. Light reflected or fluoresced by the targets illuminated individually by one illuminating beam (the targets 602 and 603) or illuminated by both beams (the target 601 within overlap area 665) pass toward the instrument 600 and are collected by a detector portion 660 of the instrument 600. The detector portion 660 consists of a 1-dimensional or 2-dimensional pixelated TOF array 661 at the image plane of an imaging lens 662. The detector portion includes timing and acquisition portions previously shown in 380. A spectrally dispersing element 663, such as a reflective or transmissive grating, prism, or the like, either individually or incorporated into a spectrometer configuration known in the art of optical spectrometry, is added to the optical path. The various spectral wavelengths associated with the targets 601-603 are focused onto portions of the array 661 determined by their position relative to the instrument 600 and the characteristics of the spectrally dispersing element 663. A slit or pinhole (not shown) at the entrance of the spectrally dispersing element 663 may be used to restrict the detector's field of view to only a region such as 667 of the scene, and may be used to improve the spectral resolution of the target of interest (e.g., the target 601) or reduce or remove signals from nearby targets (e.g., the target 603). The reflected light at the wavelengths of the illuminating light sources 610-611 or ambient light sources may be reduced or blocked in intensity through suitable optical filtering (not shown) as needed to relatively enhance the signal wavelengths of interest, such as typically much less intense fluorescence signals 653.

The spectral characteristics of the target of interest 601 may be determined by measuring the TOF pixels' integrated output upon illumination by multiple time-synchronized emitted light pulses 605, 606 and detector 660 detections. For instance, the X-direction of the pixel array 661 may be used to provide a 1-D image of one axis or cross section of the target 601, whereas the other direction (Y-) of the array 661 provides spectral information over the same target cross section. Prior mentioned methods for measuring two or more phases of time may be used to extract the desired reflected or fluoresced light signal from the out-of-range targets (e.g., 602) and to subtract the effects of time-varying ambient light. Alternating the active illuminating sources 610, 611 over various times and delays relative to the TOF detections may be used to sequentially measure the reflection or fluorescence characteristics of the target, which may provide unique temporal or spectral information of the target of interest. This may include but is not limited to detecting the concentration of chlorophyll or photosynthetic accessory pigments in algae cell targets, or measuring the fluorescence lifetimes of fluorescing materials.

The examples discussed above describe only a few instances of the invention, with applications mostly for use in aqueous environments (e.g., algae detection). It is to be understood that numerous additional embodiments or applications may be envisioned.

As another application example of the invention, a time-of-flight detector may be used to reject ambient light or pump light in a fluorescence or phosphorescence process. Fluorescence and phosphorescence processes (arising from excited atoms emitting a photon at some later time) have a decay time that can occur in the sub-picosecond to nanosecond to microsecond or longer time scale. This fluorescence is not restricted to marine applications as previously described above but can be used in a multitude of other applications such as biologically-tagged fluorescence markers in-vivo or in-situ or on, for example on a microscope slide. The time-gating and measurement of fluorescent signals and ambient signals may be used to for example improve contrast of the fluorescence particles in a displayed or digitally processed image and to remove time-varying fluctuations of ambient lighting (such as those produced by fluorescent lighting) from the measurement.

As another sensing application example, a phosphorescent surface or volume of material may be excited by a pulsed light source. The phosphorescent photons are emitted in time relative to the incident light pulse. Some phosphorescent surfaces may contain or be created using chemical or biological constituents or films, which are known to produce a change in the phosphorescence amplitude and/or delay of the average emission of photons when in the presence of some analyte desiring to be detected. As one example, a platinum octaethylporphyrin film's phosphorescence may be quenched (amplitude suppressed and phase-delayed) in the presence of oxygen. Taking the ratio of amplitudes of adjacent nano-second scale (or micro-second) time detections can yield much more accurate measurement of phase-delay or time-delay that occurs, as compared to a more conventional and slower-modulated excitation light signal that has traditionally been used to measure the phosphorescence lifetimes. With better temporal/phase measuring capability, thin, faster-responding films can be produced and utilized (the speed improvement is due to reduced molecular diffusion time constants). Ambient light sampling prior to or after the phosphorescence measures may be performed and be used to remove the effects of light leakage through the thin film.

As another sensing application, light fluorescence is imaged from a directed beam or broadly illuminated area to accentuate and/or quantify fluorescent materials. This may be useful, for example, to produce imaging-type dye tracer sensors for flow and water tracing studies or to detect leaks in liquid samples (industrial process, swimming pools, water treatment facilities, etc.).

As another sensing application, light scattering is detected instead of fluorescence. As yet another sensing application, light absorption is detected instead of scattering or fluorescence. The TOF technique can provide better discrimination of the probing signal in the presence of ambient light, when compared to current methods.

While a great many applications for the disclosed sensors based on TOF LIDAR technology have been described above, a preferred embodiment and a highly desirable application is for in-situ measurement of optical characteristics (e.g., algae concentrations) of bodies of water. To that end, a complete detector device is described below for this application.

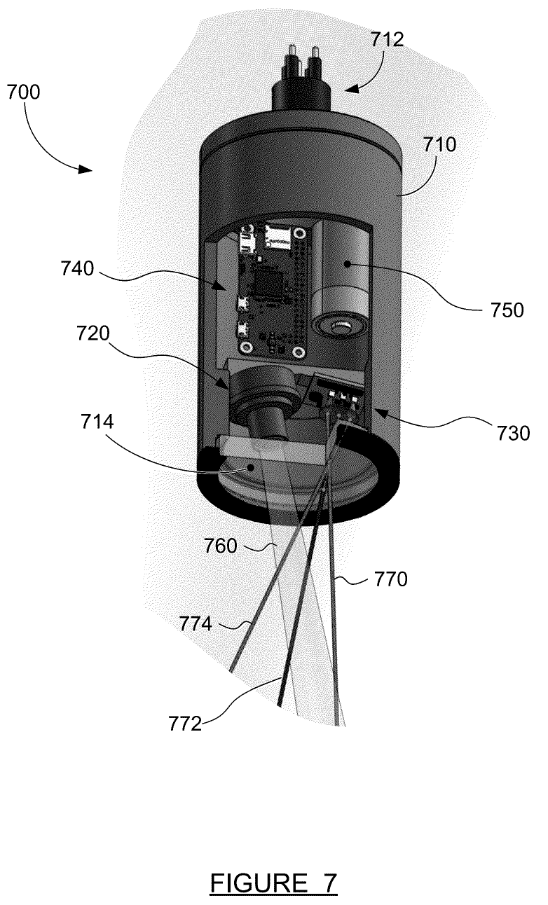

FIG. 7 is an illustration of an optical TOF LIDAR instrument 700 of the type depicted in FIG. 5, fully integrated into an underwater-deployable device with all electronics and a power supply enclosed in a pressure vessel, according to embodiments of the present disclosure. The instrument 700 is illustrated in an underwater environment as before. The instrument 700 includes a pressure vessel housing 710, partially cut-away for visibility of internal components.

The pressure vessel housing 710 is designed as a waterproof enclosure for all of the electronic and optical components discussed earlier. The housing 710 has a connector 712 on one end (i.e., the “top” end), where the connector 712 is configured for coupling to a data cable which extends up to a watercraft which is tending the instrument 700. The connector 712, or another connector, may provide coupling to a supplemental mechanical cable, such as a cable which lowers or tows the instrument 700 into/through the water.

A window 714 is located on an end of the housing 710; the window 714 is illustrated on the “bottom” of the housing 710, suitable for optical detection downward in the water column. Although not shown in detail in FIG. 7, the window 714 may be considered to include optics (filter/lens) for both the outgoing transmitted light beams and the incoming reflected light beams, as has been discussed at length earlier.

A TOF detector 720 is positioned inside the housing 710, proximal the window 714 as shown; this corresponds with the integrated circuitry 380 of FIG. 3B, and mounting components. The detector design could include a single detector element, or a 1-D linear array or a 2-D (e.g., rectangular or circular) array of detector elements. A light source module 730 is also positioned inside the housing 710 and proximal the window 714. The light source module 730 is illustrated here as having multiple illuminating sources arranged in a 1-D (linear) array of three sources. An electronics module 740 includes all of the electronic devices necessary for control of the outgoing light beams and processing of the incoming reflected light beams; this corresponds with the modules and devices 360, 390 and 398 of FIG. 3B.

An energy source (e.g., battery) 750 is also provided inside the housing 710. The battery 750 provides power to the electronics module 740, the detector module 720, and the light source module 730. Due to the design of the TOF LIDAR detector 700—with optical signal charge accumulation on capacitors and low-speed, low-power electronics performing measurement and control—the battery 750 can be expected to provide ample operational time for the instrument 700. Supplemental power may be provided by the cable connected to the connector 712 if necessary.

Below the housing 710, transmitted and reflected light beams are shown passing through the water. These include one to several collimated, pulsed light source beams (770, 772, 774), and the portion 760 of the reflected light being collected and focused onto the field of view of the detector 720. The reflected light produced by beams 770-774 may all arrive from different ranges and lateral positions in the detected signal 760 as shown, and therefore impinge at different times and positions of the detector elements in the TOF detector module 720. The pulsed light source signals 770, 772, 774 may be operated simultaneously or independently as controlled by the electronics module 740, and include different colors (wavelengths) of light pulses, which may excite fluorescence in different types of water-borne targets captured in the reflected light path 760. This has been discussed earlier, and is shown here in FIG. 7 to reinforce the concepts.

The positions of the elements as depicted in FIG. 7 are intended to illustrate one example of an underwater instrument embodying features of the present disclosure. Other embodiments including ones lacking an internal power sources 750 or having the window 714 and/or the connector 712 in different positions, or having multiple windows and connectors, would be understood to be practical by those skilled in the art.

Additional features and capabilities may be added to the instruments disclosed above, as would be understood by those skilled in the art. For example, data collected by the instruments may be uploaded (via the connector and cable) to a computer onboard the boat or ship which is operating the instrument. The computer would have a processor and storage suitable for storing the data from the instrument, processing and/or aggregating it, publishing the data to internet sites and web pages via a communication network, and so forth. In addition, operational commands may be sent to the underwater TOF instruments from the computer aboard the ship, via the cable. The commands may change operating parameters such as the character of the light pulses to send, the depth ranges to monitor, etc.

Embodiments of the devices disclosed above—in both single-pixel and pixel-array designs—have been constructed and tested, demonstrating superior performance in all aspects of measurement, including; detection accuracy, range discrimination, signal-to-noise ratio, ambient light rejection, etc. The single-pixel iTOF fluorometer delivers a combination of strong measurement capability and low cost. The multi-pixel (pixelated array) iTOF fluorometer provides added depth-ranging capability—delivering the performance benefits over traditional optical detectors as discussed throughout the present disclosure.

As will be well understood by those skilled in the art, the several and various steps and processes discussed herein to describe the disclosed instruments may be referring to operations performed by a computer, a processor or other electronic calculating device that manipulates and/or transforms data using electrical phenomenon. Those processors and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion describes merely exemplary embodiments of the present disclosure. One skilled in the art will readily recognize from such discussion and from the accompanying drawings and claims that various changes, modifications and variations can be made therein without departing from the spirit and scope of the invention as defined in the following claims.

What is claimed is:

1. An instrument for determining optical characteristics of at least one target, said instrument comprising:
a light source for emitting a pulsed light beam;
a projection lens responsive to the light beam and projecting a projected spot of the light beam onto the at least one target;
an imaging lens responsive to returned photons from the projected spot on the at least one target;
a time-of-flight (TOF) detector including at least one photodetector element, where the TOF detector includes for each photodetector element a field effect transistor (FET) switch and a capacitor for storing charge created by the returned photons striking the photodetector element, said imaging lens focusing an image of the projected spot on the TOF detector; and
processing electronics for controlling the light source and the FET switch for the at least one photodetector element and processing capacitor stored charge signals from the image of the projected spot on the TOF detector, said processing electronics determining a time from when the light beam is emitted until the image of the projected spot is created on the TOF detector so as to determine at least one of a distance to, a strength of, or an optical characteristic of the at least one target.

2. The instrument according to claim 1 wherein the returned photons from the projected spot arise from fluorescence or phosphorescence.

3. The instrument according to claim 2 wherein the fluorescence of the target arises from a biological process including photosynthetic processes, or the fluorescence of the target arises from a fluorescent material in a liquid.

4. The instrument according to claim 1 wherein the returned photons from the projected spot arise from scattering from the at least one target.

5. The instrument according to claim 1 wherein the returned photons from the projected spot arise from absorption from the at least one target.

6. The instrument according to claim 1 wherein the at least one target is not a continuous hard reflective target.

7. The instrument according to claim 1 wherein the FET switch for the at least one photodetector element is controlled by the processing electronics to open and close on a time schedule determined based on timing of individual pulses of the pulsed light beam and a designated elapsed time.

8. The instrument according to claim 7 wherein the elapsed time is determined based on a desired measurement range to the at least one target.

9. The instrument according to claim 8 wherein the elapsed time is determined based on, in addition to the desired measurement range, a lag time for the at least one target to emanate the returned photons.

10. The instrument according to claim 7 wherein at least one TOF light collection phase, occurring when the FET switch is closed, records ambient light levels.

11. The instrument according to claim 7 wherein at least one TOF light collection phase, occurring when the FET switch is closed, records signal light levels.

12. The instrument according to claim 1 further comprising optical filters configured to remove unwanted light photons.

13. The instrument according to claim 1 wherein the projection lens or the imaging lens is or includes an optical fiber configured to project the pulsed light beam to or from the target.

14. The instrument according to claim 1 wherein the light source is turned off during at least one reading in order to measure at least one characteristic of a remainder of the instrument.

15. The instrument according to claim 1 wherein a fluorescent material is placed in front of the TOF detector in order to shift energy of the returned photons to a wavelength where the TOF detector has a desired responsiveness.

16. The instrument according to claim 1 wherein at least two FET switches and charge storage capacitors are provided for each photodetector element in the TOF detector, configured to record returned photons from at least two intervals in time from when the light beam is emitted until the image of the projected spot is created on the TOF detector.

17. The instrument according to claim 16 wherein a temporal response of the returned photons is calculated through a ratio of the amount of charge in the at least two storage capacitors.

18. The instrument according to claim 1 wherein the TOF detector includes a plurality of photodetector elements arranged in a linear array or a two-dimensional array.

19. The instrument according to claim 18 wherein the light source and the TOF detector are spatially offset so that a position of the image of the projected spot on the array of photodetector elements in the TOF detector varies with distance between the instrument and the at least one target.

20. The instrument according to claim 18 further comprising a spectrally dispersing element that affects positions of the returned photons on the array of photodetector elements in the TOF detector in accordance with a wavelength of each photon.

21. The instrument according to claim 20 wherein spectral characteristics of the at least one target are determined by an of amount of charge on the capacitor for each photodetector element in the array of photodetector elements in the TOF detector.

22. The instrument according to claim 21 wherein temporal characteristics of the at least one target are determined by an of amount of charge on the capacitor for at least two photodetector elements in the array of photodetector elements in the TOF detector.

23. The instrument according to claim 18 wherein at least one region of the array of photodetector elements is used to measure a temporal or optical characteristic of the light source without being projected onto the at least one target.

24. The instrument according to claim 18 further comprising at least one additional light source configured so that the returned photons from the projected spot from each of the light sources is imaged onto a different portion of the array of photodetector elements in the TOF detector.

25. An instrument for determining optical characteristics of at least one target in an underwater environment, said instrument comprising:
a light source for emitting a pulsed light beam;
a projection lens responsive to the light beam and projecting a projected spot of the light beam onto the at least one target;
an imaging lens responsive to returned photons from the projected spot on the at least one target;
a time-of-flight (TOF) detector including at least one photodetector element, where the TOF detector includes for each photodetector element a field effect transistor (FET) switch and a capacitor for storing charge created by the returned photons striking the photodetector element, said imaging lens focusing an image of the projected spot on the TOF detector;
processing electronics for controlling the light source and the FET switch for the at least one photodetector element and processing capacitor stored charge signals from the image of the projected spot on the TOF detector, said processing electronics determining a time from when the light beam is emitted until the image of the projected spot is created on the TOF detector so as to determine at least one of a distance to, a strength of, or an optical characteristic of the at least one target;
a battery providing power to the light source, the TOF detector and the processing electronics; and
a housing having an interior volume containing the light source, the TOF detector, the processing electronics and the battery, said housing having a window through which the light beam and the returned photons pass, and an external connector.

26. The instrument according to claim 25 wherein the housing is a pressure vessel configured and sealed to prevent liquid from entering the interior volume.

27. The instrument according to claim 25 further comprising a data storage device inside the housing, the data storage device configured to store data received from the processing electronics.

28. The instrument according to claim 25 wherein the connector provides a mechanical connection, an electrical signal connection, or both, between the instrument and at least one cable leading to a remote location.

29. The instrument according to claim 28 wherein the remote location is onboard or proximal a watercraft, and the instrument is coupled to the remote location or the watercraft by the at least one cable.
